(19) United States
(12) Patent Application Publication
(10) Pub. No.: US 2012/0158495 A1
(43) Pub. Date: Jun. 21, 2012

(54) INVENTORY ALLOCATION IN ADVERTISING SYSTEMS

(76) Inventors: Jayavel Shanmugasundaram, Santa Clara, CA (US); Datong Chen, Santa Clara, CA (US); Sumanth Jagannath, Sunnyvale, CA (US); Erik Vee, San Mateo, CA (US); Ramana Yerneni, Cupertino, CA (US)

(21) Appl. No.: 12/972,941

(22) Filed: Dec. 20, 2010

(51) Int. Cl. G06Q 30/00

(52) U.S. Cl. 705/14.49

(57) ABSTRACT

A network based advertisement system includes a supply forecasting system configured to select, from a campaign log database, data that defines a plurality of contracts. Each contract specifies requirements that include contract target audience information and a number of impressions. For each contract, the supply forecasting system identifies one or more opportunity samples with characteristics that match contract target audience information of the contract. Each opportunity sample is associated with a weight that corresponds to a number of opportunities with similar characteristics. An optimizer associates the opportunity samples with the contract and then determines whether the opportunity samples are associated with other contracts. The optimizer then limits the number of opportunities associated with the samples that are allocatable to the contract based at least in part on a function of requirements of other contracts associated with the one or more samples.

### BACKGROUND

The Internet has emerged as a powerful advertising tool. It is commonplace to see advertisements on many web sites. For example, advertisements may be displayed on search web sites and may be targeted to individuals based upon search terms provided by the individuals. Other web sites, such as news and sports web sites, may provide space for advertisements. The owners of these web sites may sell advertising space to advertisers to offset the costs associated with operating the web sites as well as to turn a profit.

To place an advertisement, an advertiser may enter into a contract with a publisher that operates an ad serving system to serve a number of advertisement impressions. An impression corresponds to the display of an advertisement to a user. For example, the advertiser may purchase 10,000 impressions for $100 and may specify a particular target audience, such as users that like sports.

At a later time, the advertiser's advertisements may be served to opportunities that match the target audience. The ad serving system may be configured to serve advertisements to an opportunity according to an allocation plan. The plan may, for example, indicate that a particular advertisement should be served to matching opportunities 10% of the time.

Each opportunity may correspond to a user viewing a web page to which an advertisement may be communicated. Every time an opportunity is identified, data associated with that opportunity is stored in a database and used to forecast future opportunities. The data base may contain information related to billions of opportunities. This information may then be utilized to adjust the allocation plan.

In generating the allocation plan, an ad serving system may randomly select opportunity samples from the database above. For example, 10000 opportunities may be sampled. The ad serving system may then determine how many of the opportunity samples match existing advertisement contracts and generate the allocation plan accordingly.

One problem with this approach, however, is that a given contract may specify a relatively obscure target audience. It may be the case that a related opportunity is stored in the database. However, as the opportunity is relatively obscure, there is a high degree of likelihood that the opportunity will not be sampled. In this case, the ad serving system will assume, incorrectly, that such opportunities do not exists and, therefore, may not be able to serve the advertisement and satisfy the contract.

### BRIEF DESCRIPTION OF THE DRAWINGS

FIG. 1 is an exemplary inventory management system for booking advertisements;

FIG. 2 is an exemplary web page that may be communicated to an advertiser to enable the specification of advertisement target information;

FIG. 3 illustrates exemplary information that may be stored in a campaign log database;

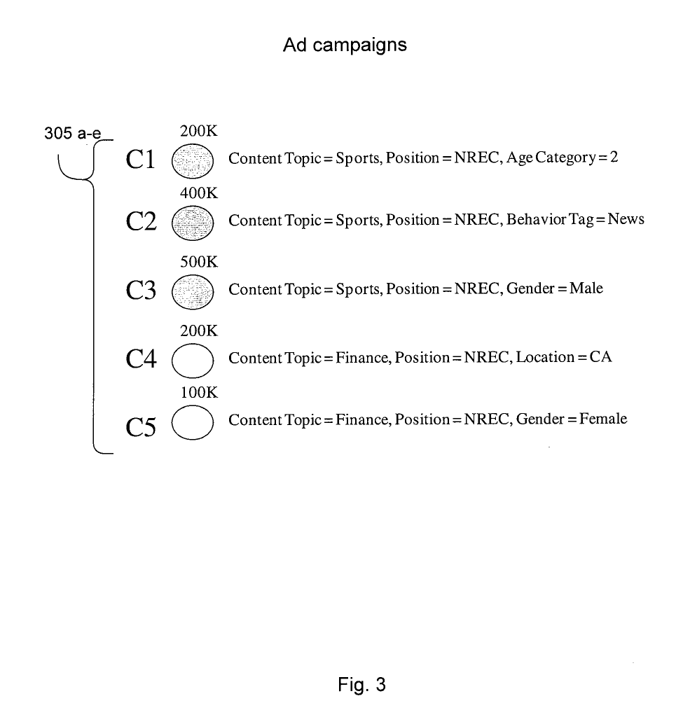

FIG. 4 illustrates exemplary information that may be stored in an ad log database;

FIG. 5 illustrates exemplary operations performed by an inventory management system;

FIG. 6 is a first exemplary graph that illustrates the association of opportunity samples to advertisement contracts;

FIG. 7 is a second exemplary graph that illustrates the association of opportunity samples to advertisement contracts; and

FIG. 8 illustrates a general computer system that may represent any of the computing devices referenced herein.

### DETAILED DESCRIPTION

The embodiments below describe an exemplary embodiment of a network based system for booking and serving advertisements. In particular, the system is configured to select opportunity samples from an opportunity database for each advertisement contract booked with the system. The system is then configured to determine whether the selected opportunities match other contracts. The system then determines an amount of inventory associated with the opportunity sample to allocate a given contract based in part on whether the opportunity sample matches multiple contracts.

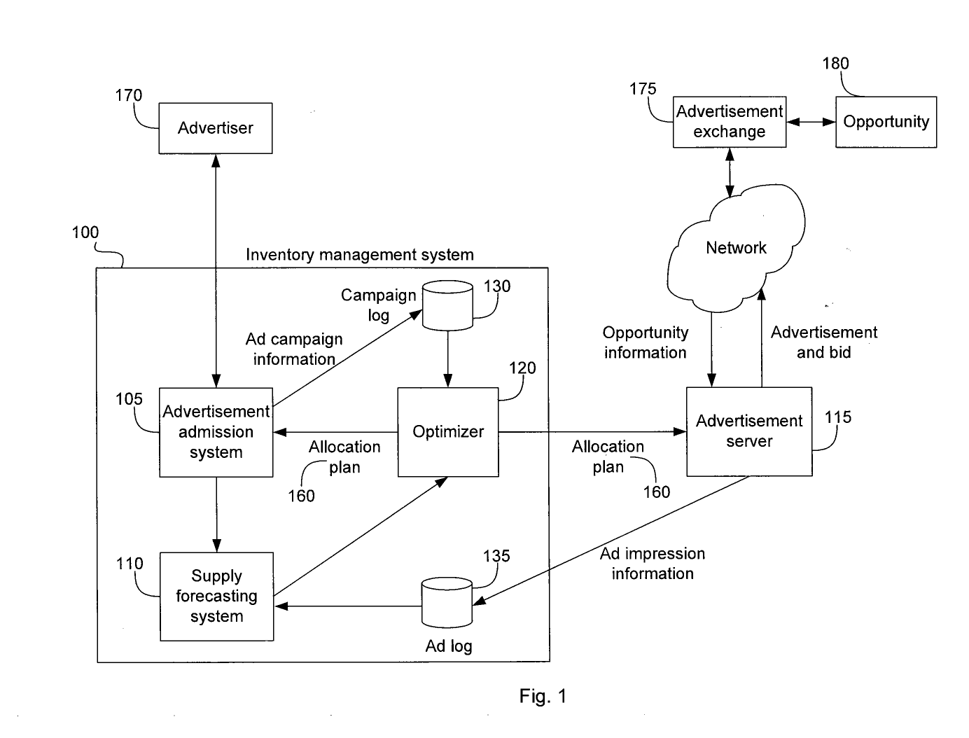

FIG. 1 is an exemplary inventory management system 100 for booking advertisements. The system 100 includes an advertisement admission system (AAS) 105, a supply forecasting system 110, and an optimizer module 120. Also shown are an advertisement server 115 (ad server) that in some implementations is part of the inventory management system 100. The various components of the system 100 may reside on a single computer system or be distributed among several computers interconnected by a communication network.

The AAS 105, supply forecasting system 110, ad server 115, and optimizer 120 may correspond to an Intel®, AMD®, or PowerPC® based computer or a different computer. The AAS 105, supply forecasting system 110, ad server 115, and optimizer 120 may include an operating system, such as a Microsoft Windows®, Linux, or other Unix® based operating system. The AAS 105, supply forecasting system 110, ad server 115, and optimizer 120 may be configured to communicate with other computers via an interface, such as a network interface.

The advertisement admission system (AAS) 105 includes code, logic, and/or other circuitry that enables advertisers 170 to enter into a contract with an advertisement network operator that operates the system 100 for the delivery of web-based advertisements. In some instances, the advertisement network operator may also correspond to a web site publisher that publishes web pages upon which advertisements are shown. The AAS 105 may communicate a web page to the advertiser 170 that enables the advertiser 170 to open an account with the publisher and provide information for setting up an advertisement campaign. The web page may enable the advertiser 170 to upload an advertisement creative, such as the graphics of an advertisement. The web page may also enable the advertiser 170 to specify advertisement information that defines the circumstances under which an advertisement is to be communicated to an opportunity (i.e., a user).

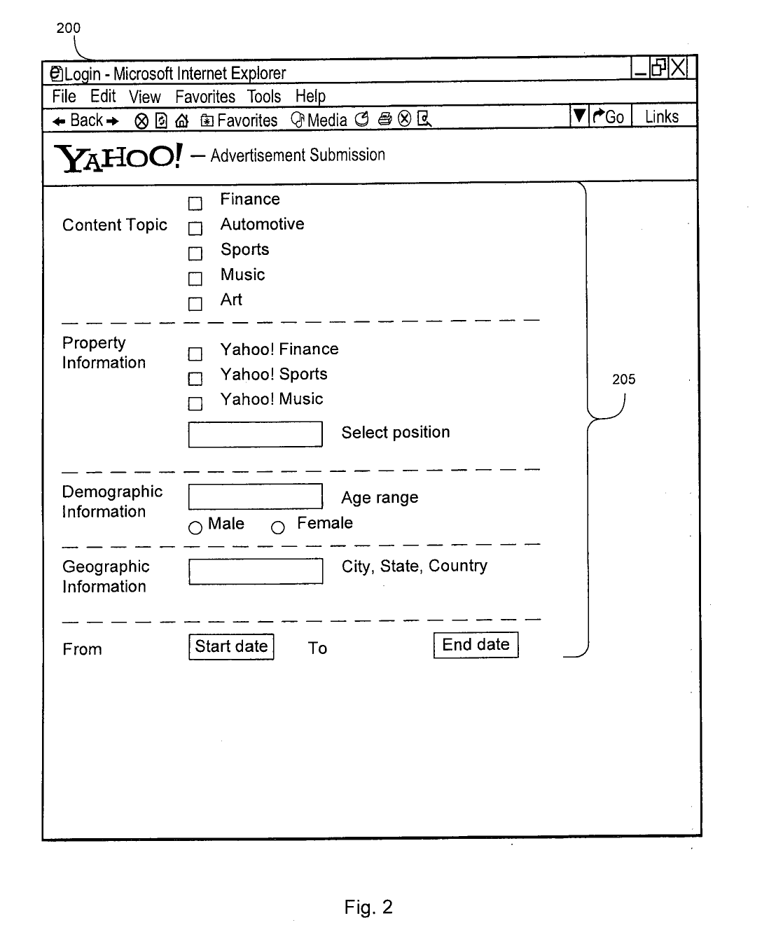

FIG. 2 is an exemplary web page 200 that may be communicated to an advertiser 170 (FIG. 1) to enable the specification of advertisement target information. The web page 200 may include target fields 205 that enable specifying the target values associated with different target categories. Exemplary target categories include content topic, property, demographic, geographic, date range, and other target categories. The target fields 205 may include fields for specifying a web page content topic such as finance, automotive, sports, music, art, a hobby or other content topic. The target fields 205 may include fields for specifying a property upon which an advertisement is to be displayed, such as Yahoo! finance, sports, music web page, or a different web page. The target fields 205 may include fields for specifying demographic information, such as an age range and gender of a target audience. The target fields 205 may include fields for specifying geographic information such as a city, state, or country of a target audience. The target fields 205 may include fields for specifying a date range within which to deliver an advertisement. Other target fields may be provided for specifying different target values.

The AAS 105 may communicate additional web pages (not shown) that enable the advertiser to book the opportunities viewed above. Information that defines a contract associated with the booking may be stored to contract data storage such as the campaign log database 130.

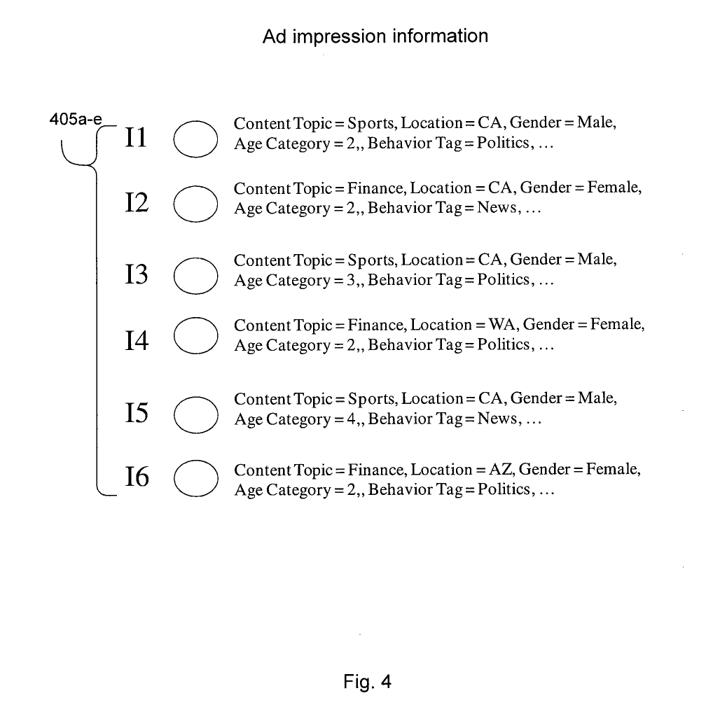

FIG. 4 illustrates exemplary information that may be stored in the campaign log database 130. Referring to FIG. 4, the campaign log database 130 stores information associated with various contracts (e.g., C1-C5) 305a-e. For each contract 305a-e, target information that defines the booked opportunities is specified. A number of opportunities booked for each contract 305a-e may be specified for each contract 305a-e. For example, 200,000 opportunities may be allocated to contract C1 305a. 400,000 opportunities may be allocated to contract C2 305b and so on. Other information associated with the various contracts 305a-e may be stored. The number of contracts shown is for illustration purposes. The actual number of stored contracts could number in the 1000s or 10s of thousands of contracts.

Returning to FIG. 1, the optimizer 120 includes code, logic, and/or circuitry that enables the generation of an allocation plan 160. The optimizer 120 is configured to communicate the allocation plan 160 to the ad server 115 and the AAS 105. The allocation plan generated by the optimizer 120 may be updated on a periodic basis, such as every few hours, so that the plan takes into consideration new estimates for supply, demand, and delivered impressions.

The allocation plan 160 defines statistical information that controls the way in which the ad server 115 matches contracts to opportunities. For example, the allocation plan 160 may instruct the ad server 115 to match contracts according to certain performance objectives. U.S. patent application Ser. No. 12/871,340, filed Aug. 30, 2010, describes methods and systems for generating such performance objectives and is hereby incorporated by reference.

The allocation plan 160 also provides instructions to the AAS 105 regarding available inventory and an amount to charge for the inventory. For example, the allocation plan 160 may specify an amount of impression inventory available that targets a particular target audience. The allocation plan 160 may also specify an amount to charge for impressions purchased from the available inventory. The AAS 105 may communicate the number of available impressions and the purchase price for the impressions to an advertiser 170 during ad submission.

The supply forecasting system 110 includes code, logic, and/or circuitry that enables forecasting an amount of inventory or opportunities available at a future date or date range based on previously served opportunities. The previously served opportunities correspond to those impressions represented the ad log database 135. The determination of the size and make-up of the future opportunity inventory is statistical in nature in that there is no guarantee that a particular opportunity will actually present itself in the future. However, the likelihood that an opportunity will arise on a certain date (i.e., that a user with certain characteristics will visit a web page) increases if similar opportunities had arrived in the past. Given that the number of impressions that may be represented in the ad log data base 135 could number in the millions per day range, the supply forecasting system 110 is configured to forecast the available inventory based on impression samples rather than all the impressions represented in the ad log database 135.

In operation, the supply forecasting system 110 receives one or more inventory search queries and determines the number of opportunities that match the queries based on the number of sample opportunities (i.e., impressions) stored in the ad log data base 135 that match the inventory queries, and a weight associated with each sample. The weight corresponds to the number of impressions in the ad log data base 135 that match the sample opportunity. The total inventory of opportunities for a query is the sum of the weights of the samples that match the query.

FIG. 4 illustrates exemplary information that may be stored in the ad log database 135. The information stored may include information that defines millions of impressions of which a few exemplary impressions 405a-e are shown. An impression 405a-e corresponds to the display or delivery of an advertisement to a user. Each impression 405a-e corresponds to an advertisement communicated to a user viewing a web page. The impression 405a-e may include data that defines the web page through which the advertisement was communicated. For example, the impression 405a-e may include the web page content type. (E.g., sports, finance, etc.). The web page may include various regions set aside for the display of advertisements. These regions are referred to as positions, such as North, South, East and West, which correspond to the top, bottom, left, and right regions, respectively, of the web page. Other regions and means for describing the regions may be provided in the information. Accordingly, each impression 405a-e may include information that defines the region of the web page associate with the impression 405a-e. In this regard, a single web page with multiple advertisement regions is capable of delivering a corresponding number of impressions 405a-e at once.

Each impression 405a-e also includes to the extent possible demographic information that characterizes the user that viewed the web page. For example, the age, gender, etc. of the user may be specified. This information may be determined based on identifying information (e.g., a cookie) communicated from the user's browser. The identifying information may be uniquely associated with the user and may enable tracking the user's habits.

Other information may include geographic information that describes the location where the advertisement was viewed, such as a city, state, zip code, etc. This information may be known based on the identifying information above or may be determined via other means, such as by determining the geographic location based on an Internet Protocol (IP) address associated with the user's browser.

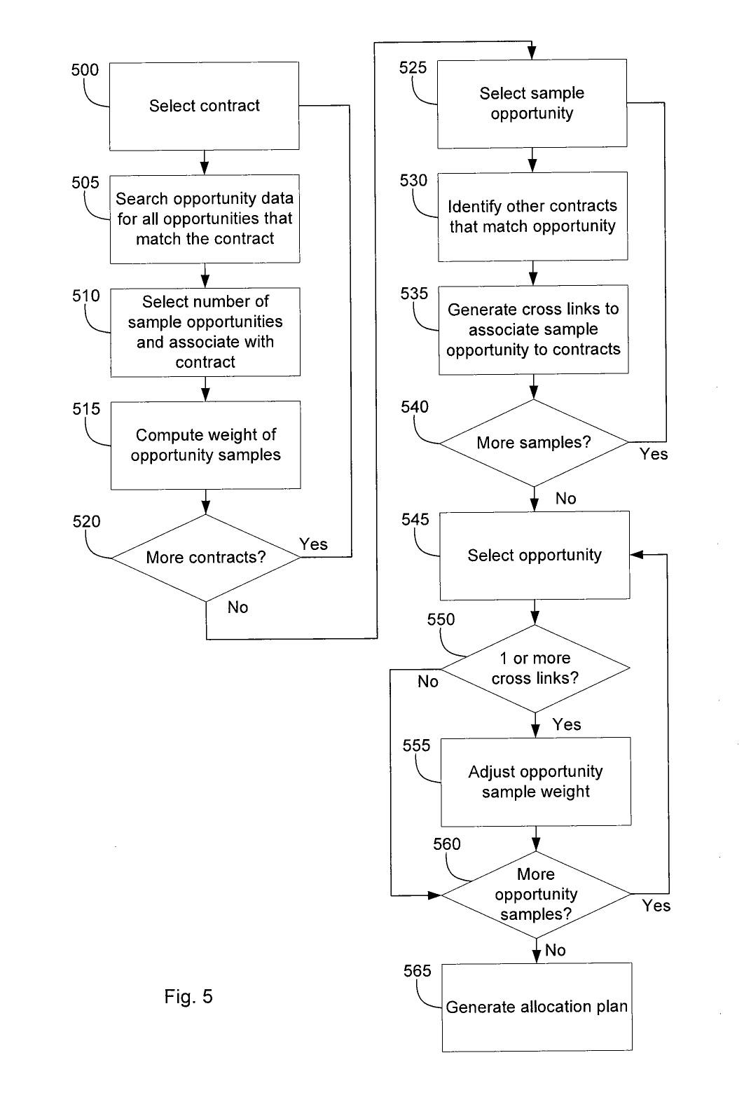

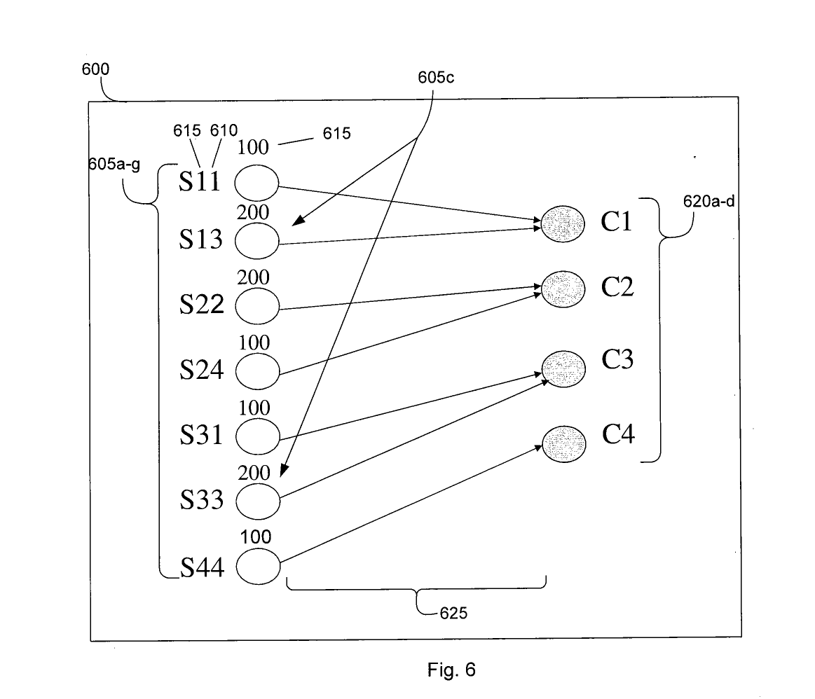

FIG. 5 illustrates exemplary operations that may performed by the inventory management system 100. The operations in FIG. 5 are best understood with reference to FIGS. 6-9. The operations performed may be different while still falling within the scope of the claims. Instructions for executing the operations may be stored in one or more non-transitory computer readable media. The instructions may be executed by any of the systems or processors described above.

At block 500, a contract is selected. That is, data that defines a contract may be selected. For example, data associated with a contract may be selected from the campaign log database 130. The contract data may specify target audience information such as the target categories and target values described above. The contract data my further specify a number of impressions. The number of impressions corresponds to an amount of times an advertisement associated with the contract is to be shown to opportunities with characteristics that match that target information.

At block 505, opportunity samples that match the contract target audience information may be selected. For example, the supply forecasting system 110 may search the ad log database 135 for opportunities with characteristics that match the target values of the contract selected at block 500. As noted above, the ad log database 135 stores data associated with impressions served in the past. The data includes, for example, content type information associated with a web page through which a past impression was served. The data may also include property information associated with the web page. Demographic information associated with the user may be stored. The data may include other information associated with the user and the web page through which the advertisement was viewed. Other data associated with the impression may be included.

The forecasting system 110 may return any number of opportunities that match the contract. For example, the forecasting system 110 may return one million opportunities that match the contract.

At block 510, a subset of the opportunities identified at block 505 (i.e. opportunity samples) may be selected and associated with the contract. The number of samples selected may be limited to a certain quantity. For example, one thousand samples may be selected for each contract. The quantity may be set based on various factors including the amount of processing power available for determining available opportunity inventory. As noted above, the availability of future inventory is statistical in nature. The prediction of future inventory improves with an increased number of samples. Conversely, the prediction is less accurate when the number of samples is small.

The opportunity samples may be associated with the contract. For example, data that defines a link between the contract and the opportunity may be generated and added to a database of links. In addition or alternatively, the links may be represented by a pointer to the opportunity data in the ad log database may be stored to the contract data in the campaign log database. The opportunity may be associated with the contract through other means known to those of skill in the art.

At block 515, a weight may be determined for each of the opportunity samples selected at block 505. The weight of a given opportunity sample corresponds the number of opportunities identified at block 505. In this case, if a million opportunities matched the contract and the number of opportunity samples selected from those opportunities is, for example 1000, each opportunity sample is assigned a weight of ten thousand. (i.e., the number opportunities that match divided by the number of opportunity samples). The weight essentially indicates that the opportunity sample represents that number of opportunities. The represented opportunities are not necessarily identical to the opportunity sampled. Rather, the represented opportunities have characteristics that match the target values of the contract selected at block 500. In other words, from the perspective of a given contract, the opportunities are the same. For example, a contract that only specifies a target audience of males will match opportunities that correspond to males in California, New York, males with different hobbies, etc. The individual opportunities are different is certain aspects, but are the same as far as the contract is concerned.

At block 520, the next contract in the campaign log database 130 is selected and the process repeats at block 500 until the campaign log database 130 has been searched for opportunity samples associated with all the selected contracts.

The various contract to opportunity sample associations generated above are represented by the exemplary graph 600 of FIG. 6. Shown are opportunity samples 605a-g, contracts 620a-d and links 625. Each opportunity sample 605a-g is designated by a two digit number that represents a sample number 610 and a contract number 615 associated with the opportunity sample 605a-g. A weight 615 for each opportunity sample 605a-g is also shown. As noted above, the weight 615 represents the number of opportunities (i.e., opportunities in the ad log database 135) with characteristics (e.g., content top, demographic, geographic, etc., information) that match a given contract 620a-d target values.

The sample number 610 uniquely identifies the opportunity sample 605a-g. For example, in the graph 600 although there appear to be 7 opportunity samples, there are in fact only 4 unique samples numbered 1-4. For example, opportunity sample S11 605a and S31 correspond to the same opportunity sample identified in the ad log database 135. The contract number corresponds to the contract selected at block 500 that matched the opportunity sample 605a-g. For example, contract S11 605a indicates that opportunity sample number 1 was matched to contract 1 and S31 indicates that opportunity sample 1 was matched to contract 3. In other words, the same opportunity sample 605a matched both contracts C1 and C3 620ac. This may occur where, for example, the opportunity sample represents all males in Nebraska that viewed an advertisement via a sports web page, target audience information for contract C1 620a specifies all males in Nebraska, and target audience information for contract C3 620c specifies all males that viewed sports web pages. In this case, both contracts 620ac matched the opportunity sample 605a because both specified a target audience that included males.

The contracts 620a-d may correspond to contracts stored in the campaign log database 130. The links 625 between the opportunity samples 605a-d and the contracts 620a-d represent an association between a given sample 605a-d and a contract 620a-d.

Returning to FIG. 5, at block 525, an opportunity sample selected at block 505 above is selected. At block 530, a determination is made as to whether the opportunity matches other contracts.

At block 535, if the opportunity matches other contracts, then a cross link representing the match is generated and stored. The cross link may be represented and stored in a manner similar to the link described above.

At block 540, if there are more opportunity samples, then the operations repeat from block 535.

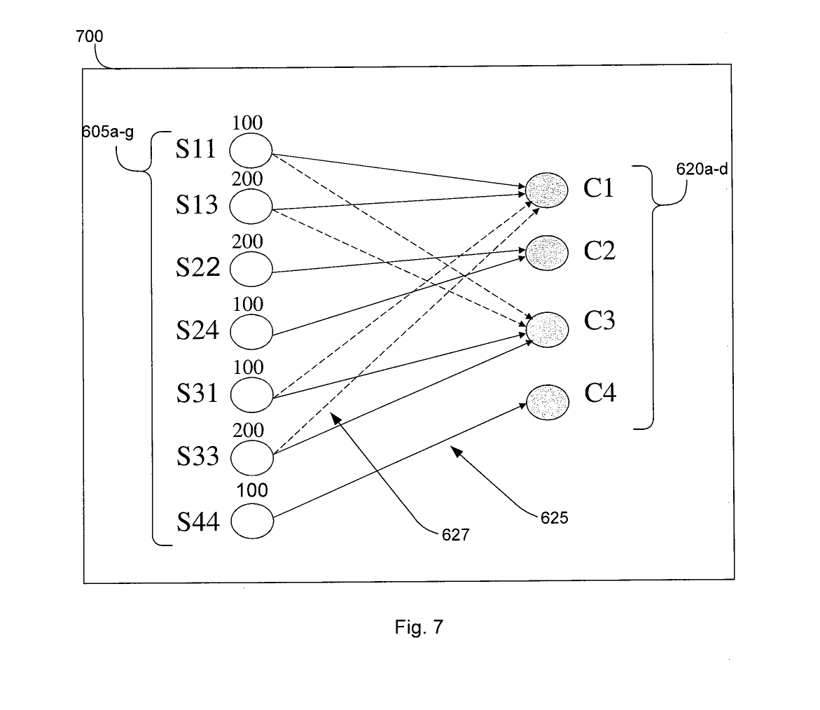

FIG. 7 is a graph that illustrates the cross linking of opportunity samples 605a-g and all the contracts 620a-d selected at block 500. The links 625 connecting opportunity samples 605a-g to contracts 620a-d correspond to the links 625 in FIG. 6 and represent an association between a contract 620a-d selected at block 500 and opportunity samples 605a-g matched at block 505 and selected at block 510. The dashed lines 627 represent a cross link (i.e., association) between a different contract 620a-d and the opportunity sample 605a-g. For example, sample S11 605a was determined to be associated with contract C1 620a at block 510. In block 525, opportunity sample S11 605a is further determined to be associated with contract C3 620c,

The cross links 627 in the graph 700 represents the contention between opportunity samples and contracts. For example, based on the graph in FIG. 6, it initially appeared as though contract C1 620a had an eligible supply of opportunities equal to the sum of the weights of opportunity sample S11 605a and S13 605b, or 300. However, the cross link 627 connecting opportunity sample S11 605a to contract C3 620c indicates that some of the opportunities represented by opportunity sample S11 605a also match contract C3 620c target audience requirements and therefore might also be allocatable to contract C3 620c. In other words, it cannot be assumed that all the opportunities represented by opportunity sample S11 605a are eligible for contract C1 620a.

Blocks 545-565 illustrate one exemplary implementation for determining a number of opportunities from a given sample that are eligible for a contract.

At block 545, an opportunity is selected. The opportunity corresponds to the opportunities identified and cross linked above.

At block 550, if the numbers of cross links to the sample opportunity are greater than or equal to one, then the weight of that opportunity is adjusted.

In one implementation, the weight of the sample opportunity is adjusted as follows: For each sample opportunity that is cross linked, consider all the contracts with which the opportunity is linked and cross linked. Let the eligible amount of supply for a contract be {E1, . . . En}, where E1 is the eligible supply of opportunities for contract C1, E2 is the eligible supply of opportunities for contract C2 and so on. The new weight for the opportunity sample may be calculated as:

W′=1/(sum of Ki/Ei),

where Ki is the number of opportunity samples taken for contract Ci. In other words, Ki corresponds to the number of opportunity selected that match contract Ci in blocks 500-515.

If the number of opportunities selected for each contract are the same, then the formula may be rewritten as:

W′=(1/K)*(1/(sum of 1/Ei)).

For example, if a given opportunity sample is cross linked to contracts C1 and C2 and the eligible supply amounts for the respective contracts is E1 and E2, and three opportunity samples were selected for each contract, the new weight for the given opportunity becomes:

W′=(⅓)*(1/(1/E1+1/E2))=(E1*E2)/(3*(E1+E2))

By way of example, suppose there are six samples S1-S6, where each opportunity sample has a weight (e.g., WS1=100, WS2=100, WS3=100, WS4=200, WS5=200, WS6=200.). Suppose further that there are two contracts, C1 and C2. Next, suppose that C1 is linked to S1, S2, and S3, and that C2 is linked to S4, S5, and S6. Given this scenario, it would appear that there is an eligible supply for C1 (E1) of 300 opportunities (i.e., the sum of WS1, WS2, and WS3), and that there is an eligible supply for C2 (E2) of 600 opportunities (i.e., the sum of WS5, WS5, and WS6). These various links may have been determined via block 500-520.

However, upon performing the operations between block 525-545, it is determined that C2 is cross linked to S3. That is, opportunity sample S3 matches C2 as well as C1. Via the operations at block 550, only S3 would have been determined to have one or more cross links. Therefore, the weight for opportunity sample S3 would be recomputed as:

WS3new=1/(3/300+3/600)=(300*600)/(3*(300+600))=200/3=67.

Based on this new weight, the number of eligible opportunities for contract C1 (E1) becomes 667 (i.e., sum of WS1, WS2, and WS3new). Along the same logic, E2 becomes 667. In other words, some of the eligible supply from C1 has shifted to C2.

The example above was rather simplistic in that only a few samples and contract were specified. In practice, the number of opportunities and contracts would be much larger resulting in a correspondingly large number of cross links. The larger number of cross links would result in a more accurate determination of the number of opportunities that are eligible for each contract.

At block 560, if there are additional opportunity samples then the operations repeat from block 545.

At block 565, an allocation plan for the contracts is computed based on the graph 700 (FIG. 7) with the weights adjusted according to the operations above. The allocation plan 120 is then communicated to the advertisement server 115, which then serves advertisements to opportunities according to the allocation plan 120. The operations above result in an allocation plan 120 that takes into consideration all contracts including those that may be targeting obscure target audiences, which might otherwise be missed if using conventional sampling operations.

In alternative implementations, the eligible number of opportunities from a given opportunity may be determined differently than as described in blocks 550-560. For example, rather than select each opportunity sample, cross links may be selected and considered one at a time. For each cross link, the two contracts related via the common opportunity sample are re-evaluated. Specifically, the weights of all the opportunity samples for those two contracts are adjusted

For example, following the example above in block 555, for a given cross link from S3 to C2, opportunity samples S4, S5 and S6 will have a weight of 200*600/700=1200/7. Opportunity sample S3 will have a weight of 100*600/700=600/7. Opportunity sample S1 and S2 will have a weight of 100*300/(200+600/7). The eligible supply for C2 is therefore 3*1200/7+600/7=600, and the eligible supply for C1 is 2*100*300/(200+600/7)+600/7=200*300/285+85=295. These operations may be repeated for all the cross links.

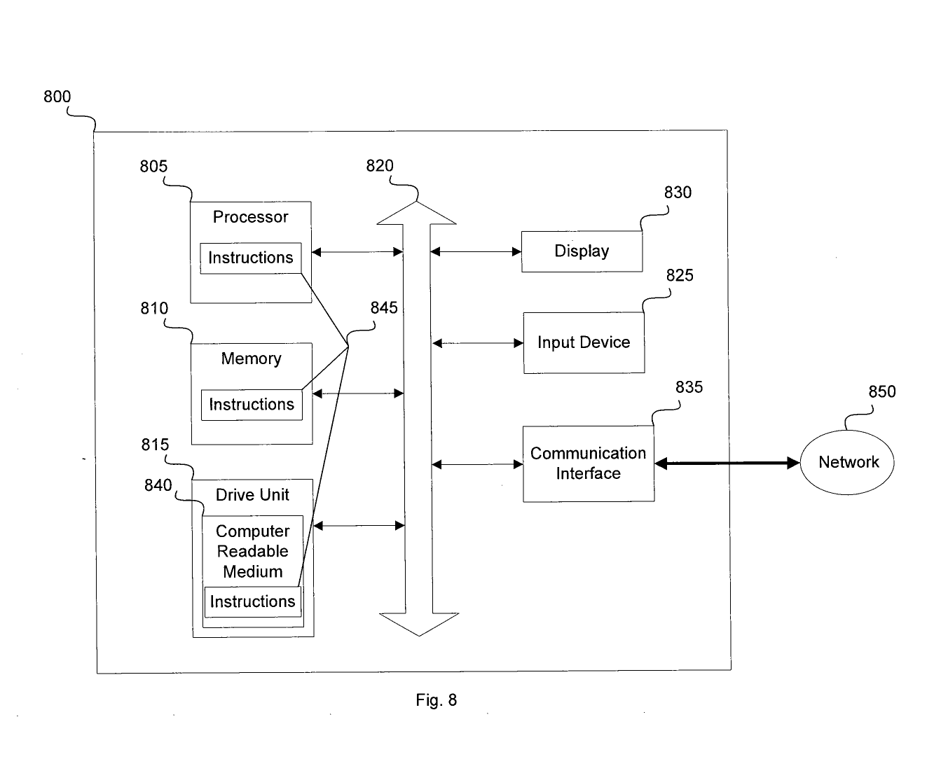

FIG. 8 illustrates a general computer system 800, which may represent the AAS 105, the supply forecasting system 110, the optimizer 120, the ad server 115, or any other computing devices referenced herein. The computer system 800 may include a set of instructions 845 that may be executed to cause the computer system 800 to perform any one or more of the methods or computer-based functions disclosed herein. The computer system 800 may operate as a stand-alone device or may be connected, e.g., using a network, to other computer systems or peripheral devices.

In a networked deployment, the computer system 800 may operate in the capacity of a server or as a client-user computer in a server-client user network environment, or as a peer computer system in a peer-to-peer (or distributed) network environment. The computer system 800 may also be implemented as or incorporated into various devices, such as a personal computer or a mobile device, capable of executing a set of instructions 845 (sequential or otherwise) that specify actions to be taken by that machine. Further, each of the systems described may include any collection of sub-systems that individually or jointly execute a set, or multiple sets, of instructions to perform one or more computer functions.

The computer system 800 may include one or more memory devices 810 on a bus for communicating information, such as the campaign log database 130 (FIG. 1) and/or the ad log database 135. In addition, code operable to cause the computer system to perform any of the acts or operations described herein may be stored in the memory 810. The memory 810 may be a random-access memory, read-only memory, programmable memory, hard disk drive or any other type of memory or storage device.

The computer system 800 may include a display 830, such as a liquid crystal display (LCD), a cathode ray tube (CRT), or any other display suitable for conveying information. The display 830 may act as an interface for the user to see the functioning of the processor 805, or specifically as an interface with the software stored in the memory 810 or in the drive unit 815.

Additionally, the computer system 800 may include an input device 825, such as a keyboard or mouse, configured to allow a user to interact with any of the components of system 800.

The computer system 800 may also include a disk or optical drive unit 815, such as the high-latency storage 110 (FIG. 1). The disk drive unit 815 may include a computer-readable medium 840 in which one or more sets of instructions 845, e.g. software, can be embedded. Further, the instructions 845 may perform one or more of the operations as described herein. The instructions 845 may reside completely, or at least partially, within the memory 810 and/or within the processor 805 during execution by the computer system 800. The memory 810 and the processor 805 also may include computer-readable media as discussed above.

The computer system 800 may include a communication interface 835 that enables communications via a network 850. The network 850 may include wired networks, wireless networks, or combinations thereof. The communication interface 835 network may enable communications via any number of communication standards, such as 802.11, 802.12, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

As shown, the described system and operations advantageously enable serving opportunities to contracts that may specify somewhat obscure target audience requirements. In particular, the system is configured to select opportunity samples from an opportunity database for each contract for serving advertisements. The system is then configured to determine whether the selected opportunities match other contracts. The system then determines an amount of opportunity inventory associated with the opportunity sample to allocate a given contract. These operations result in an allocation plan that takes into consideration all contracts.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A network based advertisement method, the method comprising:
selecting, from contract data storage, data that defines a plurality of contracts where each contract of the plurality of contracts specifies requirements that include target audience information and a number of impressions, where an impression corresponds to the communication of an advertisement to a user;
selecting, from opportunity data storage, one or more opportunity samples with characteristics that match the target audience information of the plurality of contracts, wherein each contract is considered individually during selection of the one or more opportunity samples, and associated with the selected one or more opportunity samples to thereby ensure that the contract is represented by at least one of the one or more opportunity samples;
associating a weight with each of the selected one or more opportunity, wherein the weight corresponds to a number of advertising opportunities represented by each opportunity sample;
determining whether the one or more opportunity samples are associated with other contracts of the plurality of contracts; and
modifying the weights of the one or more opportunity samples based at least in part on a function of the determined associations of the one or more opportunity samples with the plurality of contracts.

2. The method according to claim 1, wherein the modification of the weights is performed by considering one opportunity sample at a time.

3. The method according to claim 1, wherein the modification of the weights is performed by considering one association at a time between the opportunity samples and the other contracts.

4. The method according to claim 1, wherein the target audience information includes target values associated with target categories from the list of categories consisting of: a content topic category, property category, demographic information category, geographic information category, and a date range category, advertisement position category, advertisement type category.

5. The method according to claim 1, wherein the opportunity data storage stores data associated with advertisement impressions, where an advertisement impression corresponds to the display of an advertisement to a user.

6. The method according to claim 1, further comprising generating an allocation plan that defines the allocation of the number of opportunities from the one or more opportunity samples to the plurality of contracts and communicating the allocation plan to an advertisement server.

7. The method according to claim 1, wherein the opportunity data storage includes data that defines one or more impressions delivered to users.

8. The method according to claim 7, further comprising receiving the data that defines the one or more impressions from an advertisement server configured to serve advertisements to a user.

9. The method according to claim 7, wherein each of the one or more impressions is associated with one or more of: a content topic category of a web page, a property category of a web page, demographic information associated with a user, geographic information associated with a user, and a date on which the user viewed the impression.

10. The method according to claim 1, further comprising selecting a same number of opportunity samples for each contract.

11. The method according to claim 1, further comprising selecting a different number of opportunity samples for at least some of the plurality of contracts.

12. A network based advertisement system comprising:
a supply forecasting system configured to select, from contract data storage, data that defines a plurality of contracts where each contract of the plurality of contracts specifies requirements that include contract target audience information and a number of impressions, where an impression corresponds to the communication of an advertisement to a user; and
an advertisement admission system configured to:
select one or more opportunity samples with characteristics that match the target audience information of the plurality of contracts, wherein in each contract is considered individually during selection of the one or more opportunity samples, and associated with the selected one or more opportunity samples to thereby ensure that the contract is represented by at least one of the one or more opportunity samples;
associate a weight with each of the selected one or more opportunity, wherein the weight corresponds to a number of advertising opportunities represented by each opportunity sample;
determine whether the one or more opportunity samples are associated with other contracts of the plurality of contracts; and
modify the weights of the one or more opportunity samples based at least in part on a function of the determined associations of the one or more opportunity samples with the other contracts of the plurality of contracts.

13. The system according to claim 12, wherein the target audience information includes target values associated with target categories from the list of categories consisting of: a content topic category, property category, demographic information category, geographic information category, and a date range category.

14. The system according to claim 12, wherein the opportunity data storage stores data associated with advertisement impressions, where an advertisement impression corresponds to the display of an advertisement to a user.

15. The system according to claim 12, wherein the advertisement admission system is further configured to generate an allocation plan that defines the allocation of the number of opportunities from the one or more opportunity samples to the contract and communicating the allocation plan to an advertisement server.

16. The system according to claim 12, wherein the opportunity data storage includes data that defines one or more impressions delivered to users.

17. The system according to claim 16, wherein the network based advertisement include data storage logic configured to receive the data that defines the one or more impressions from an advertisement server configured to serve advertisements to a user.

18. The system according to claim 16, wherein each of the one or more impressions is associated with one or more of: a content topic category of a web page, a property category of a web page, demographic information associated with a user, geographic information associated with a user, and a date on which the user viewed the impression.

19. A non-transitory machine-readable storage medium having stored thereon a computer program comprising at least one code section for operating a networked based advertisement system, the at least one code section being executable by a machine for causing the machine to perform acts of:
selecting data that defines a plurality of contracts where each contract of the plurality of contracts specifies requirements that include target audience information and a number of impressions, where an impression corresponds to the communication of an advertisement to a user;
selecting one or more opportunity samples with characteristics that match the target audience information of the plurality of contracts, wherein in each contract is considered individually during selection of the one or more opportunity samples, and associated with the selected one or more opportunity samples to thereby ensure that the contract is represented by at least one of the one or more opportunity samples;
associating a weight with each of the selected one or more opportunity, wherein the weight corresponds to a number of advertising opportunities represented by each opportunity sample;
determining whether the one or more opportunity samples are associated with other contracts of the plurality of contracts; and
modifying the weights of the one or more opportunity samples based at least in part on a function of the determined associations of the one or more opportunity samples with the other contracts of the plurality of contracts.

20. The non-transitory machine-readable storage according to claim 19, wherein the target audience information includes target values associated with target categories from the list of categories consisting of: a content topic category, property category, demographic information category, geographic information category, and a date range category.

21. The non-transitory machine-readable storage according to claim 19, wherein the opportunity data storage stores data associated with advertisement impressions, where an advertisement impression corresponds to the display of an advertisement to a user.

22. The non-transitory machine-readable storage according to claim 19, wherein the at least one code section is executable by the machine for causing the machine to perform acts of generating an allocation plan that defines the allocation of the number of opportunities from the one or more opportunity samples to the contract and communicating the allocation plan to an advertisement server.

23. The non-transitory machine-readable storage according to claim 19, wherein the opportunity data storage includes data that defines one or more impressions delivered to users.

24. The non-transitory machine-readable storage according to claim 23, wherein the at least one code section is executable by the machine for causing the machine to perform acts of receiving the data that defines the one or more impressions from an advertisement server configured to serve advertisements to a user.

25. The non-transitory machine-readable storage according to claim 23, wherein each of the one or more impressions is associated with one or more of: a content topic category of a web page, a property category of a web page, demographic information associated with a user, geographic information associated with a user, and a date on which the user viewed the impression.
